(19) United States
(12) Patent Application Publication
(10) Pub. No.: US 2025/0261286 A1
(43) Pub. Date: Aug. 14, 2025

(54) HEAT CABLE SYSTEM

(71) Applicant: Vermont State & Copper Services, Inc., Morrisville, VT (US)

(72) Inventors: Brian Stearns, Lake Geneva, WI (US); Mike Carter, Ontario (CA); Kris Michaud, Morrisville, VT (US); Daniel Beam, Morrisville, UT (US); Kelly Player, Morrisville, UT (US)

(21) Appl. No.: 19/049,996

(22) Filed: Feb. 10, 2025

Related U.S. Application Data
(60) Provisional application No. 63/551,961, filed on Feb. 9, 2024.

(51) Int. Cl. H05B 3/56

(52) U.S. Cl. CPC H05B 3/56

(57) ABSTRACT

Heat cable systems described in the present disclosure may comprise a housing, a fastener and a heat cable. The housing may comprise a first portion and a second portion. The first portion may be removably coupled to the second portion. The hosing may define a first channel and a second channel. The housing may define a first insulating cavity, a second insulating cavity, a third insulating cavity and a fourth insulating cavity. The first channel may be disposed between the first insulating cavity and the second insulating cavity. The second channel may be disposed between the third insulating cavity and the fourth insulating cavity. The heat cable may be disposed in the first channel and the second channel. The heat cable may be in contact with a portion of the housing defining the first channel.

### CROSS-REFERENCE TO RELATED APPLICATIONS

This application claims the benefit of U.S. Provisional Application Ser. No. 63/551,961 filed on Feb. 9, 2024 and entitled, “HEAT CABLE SYSTEM,” which is incorporated herein by reference.

### FIELD

The present disclosure relates to ice and/or snow management systems. More particularly, the present disclosure relates to a heat cable system to manage ice and/or snow in building gutters and on high rise building ledges.

### BACKGROUND

Snow and ice accumulation on building roofs, gutters, and ledges poses risks such as structural damage, water leakage, and potential hazards to pedestrians from falling ice. Traditional methods for managing these challenges include manual removal, which can be labor-intensive and dangerous, or the application of chemical de-icers, which may be harmful to the environment and building materials.

To address these issues, heat cable systems have been developed to provide an automated, efficient, and environmentally friendly solution. These systems utilize electrically heated cables to melt snow and ice, ensuring that water flows freely through gutters and off roof edges, thereby reducing the risk of ice dams and icicles forming. By maintaining clear drainage pathways, heat cable systems help protect the structural integrity of buildings and enhance safety for occupants and passersby. Summary

In various embodiments, a heat cable system may comprise a housing, a fastener and a heat cable. The housing may comprise a first portion and a second portion. The first portion may be removably coupled to the second portion. The hosing may define a first channel and a second channel. The housing may define a first insulating cavity, a second insulating cavity, a third insulating cavity and a fourth insulating cavity. The first channel may be disposed between the first insulating cavity and the second insulating cavity. The second channel may be disposed between the third insulating cavity and the fourth insulating cavity. The fastener may be installable through the housing to secure the housing to a structure. The heat cable may be disposed in the first channel and the second channel. The heat cable may be in contact with a portion of the housing defining the first channel.

In various embodiments, a heat cable housing may comprise a first portion and a second portion. The first portion may be removably coupled to the second portion. The hosing may define a first channel, and a second channel disposed between the first portion and the second portion. The housing may define a first insulating cavity, a second insulating cavity, a third insulating cavity and a fourth insulating cavity. The first channel may be disposed between the first insulating cavity and the second insulating cavity. The second channel may be disposed between the third insulating cavity and the fourth insulating cavity.

In various embodiments, the portion of the housing may be thicker than an outer portion of the housing. The portion of the housing may be configured to facilitate heat transfer through the housing. The fastener may be installable through the second portion in at least one of the first insulating cavity, the second insulating cavity, the third insulating cavity and the fourth insulating cavity. The first portion and the second portion may be a clam shell assembly.

In various embodiments, the heat cable system may further comprise a central channel disposed between the second insulating channel and the third insulating channel. The central channel may extend along an entire length of the housing.

In various embodiments, the first portion and the second portion define portion of the housing that may have a first wall thickness. An outer portion of the first portion may be exposed to the environment. The outer portion may have a second wall thickness. The first wall thickness may be greater than the second wall thickness.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1A illustrates a cross-sectional view of a first housing assembly and fasteners, in accordance with various embodiments.

FIG. 1B illustrates a cross-sectional view of a first housing assembly and fasteners, in accordance with various embodiments.

FIG. 2 illustrates a cross-sectional view of a second housing assembly and fasteners, in accordance with various embodiments.

FIG. 3 illustrates a cross-sectional view of a third housing assembly and fasteners, in accordance with various embodiments.

FIG. 4 illustrates a cross-sectional view of a fourth housing assembly, in accordance with various embodiments.

FIG. 5 illustrates a perspective view of a heat cable system deployed with a solar panel array, in accordance with various embodiments.

FIG. 6A illustrates a cross-sectional view of a first bracket assembly as a heat cable system, in accordance with various embodiments.

FIG. 6B illustrates a cross-sectional view of a second bracket assembly as a heat cable system, in accordance with various embodiments.

FIG. 7A illustrates a perspective view of a heat cable system deployed as part of a railing, in accordance with various embodiments.

FIG. 7B illustrates a cross-sectional view of a first rail system with a heat cable system, in accordance with various embodiments.

FIG. 7C illustrates a cross-sectional view of a second rail system with a heat cable system, in accordance with various embodiments.

FIG. 8A illustrates a perspective view of a heat cable system deployed as part of a window louver system, in accordance with various embodiments.

FIG. 8B illustrates a cross-sectional view of a first louver with a heat cable system, in accordance with various embodiments.

FIG. 8C illustrates a cross-sectional view of a second louver with a heat cable system, in accordance with various embodiments.

FIG. 9A illustrates a cross-sectional view of a first tube assembly with a heat cable system, in accordance with various embodiments.

FIG. 9B illustrates a cross-sectional view of a second tube system with a heat cable system, in accordance with various embodiments.

FIG. 10 illustrates a perspective view of a heat cable system deployed as part of a roof drain system, in accordance with various embodiments.

FIG. 11A illustrates a cross-sectional view of a first pipe assembly with a heat cable system, in accordance with various embodiments.

FIG. 11B illustrates a cross-sectional view of a second pipe system with a heat cable system, in accordance with various embodiments.

FIG. 12A illustrates a perspective view of a heat cable system deployed as part of a pipe style snowguard system, in accordance with various embodiments.

FIG. 12B illustrates a cross-sectional view of a first pipe with a heat cable system, in accordance with various embodiments.

FIG. 12C illustrates a cross-sectional view of a second pipe with a heat cable system, in accordance with various embodiments.

FIG. 14A illustrates a perspective view of a ledge style snowguard system with a heat cable system, in accordance with various embodiments.

FIG. 14B illustrates a cross-sectional view of a first ledge guard style snowguard system with a heat cable system, in accordance with various embodiments.

FIG. 14C illustrates a cross-sectional view of a second ledge guard style snowguard system with a heat cable system, in accordance with various embodiments.

FIG. 14D illustrates a cross-sectional view of a portion of second ledge guard style snowguard system with a heat cable system, in accordance with various embodiments.

FIG. 15A illustrates a perspective view of a radio tower with a heat cable system, in accordance with various embodiments.

FIG. 15B illustrates a cross-sectional view of a radio tower system with a heat cable system, in accordance with various embodiments.

FIG. 16A illustrates a perspective view of a heat cable system deployed with a tractor trailer, in accordance with various embodiments.

FIG. 16B illustrates a view of a heat cable system with clamps, in accordance with various embodiments.

FIG. 16C illustrates a cross-sectional view of a snow bar with a heat cable system, in accordance with various embodiments.

FIG. 17A illustrates a perspective view of a building with a heat cable system, in accordance with various embodiments.

FIG. 17B illustrates a perspective view of a gutter with a heat cable system, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

The present disclosure focuses on an advanced heat cable system designed to manage ice and snow more effectively. In various embodiments, the systems disclosed herein incorporates housing assemblies and fasteners to secure the cables in place, ensuring consistent performance in harsh weather conditions.

In various embodiments, the heat cable systems disclosed herein are configured to melt ice in gutters and on building ledges. The heat cable systems may include a metal housing that is configured to receive one or more heat cables. The housing may be installed on a building ledge or in a building gutter. When the environment reaches a certain temperature, the heat cable may be actuated inside the housing, causing the housing to heat up and melt any snow or ice on building ledges or in building gutters.

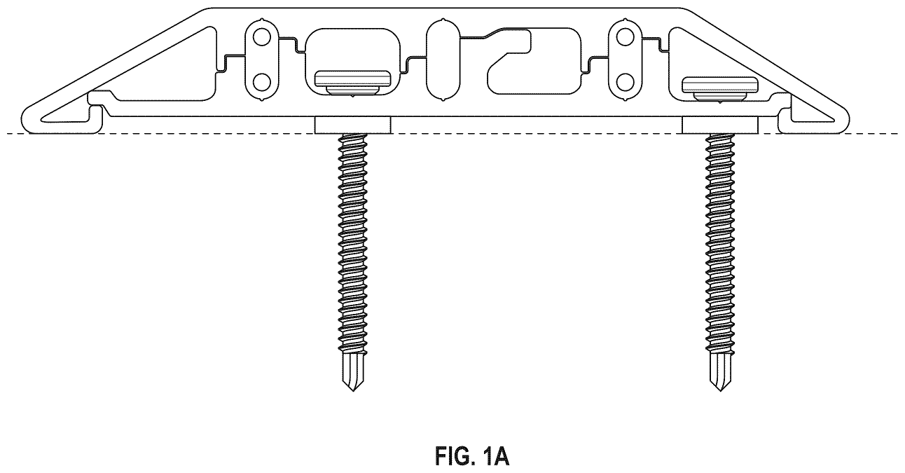

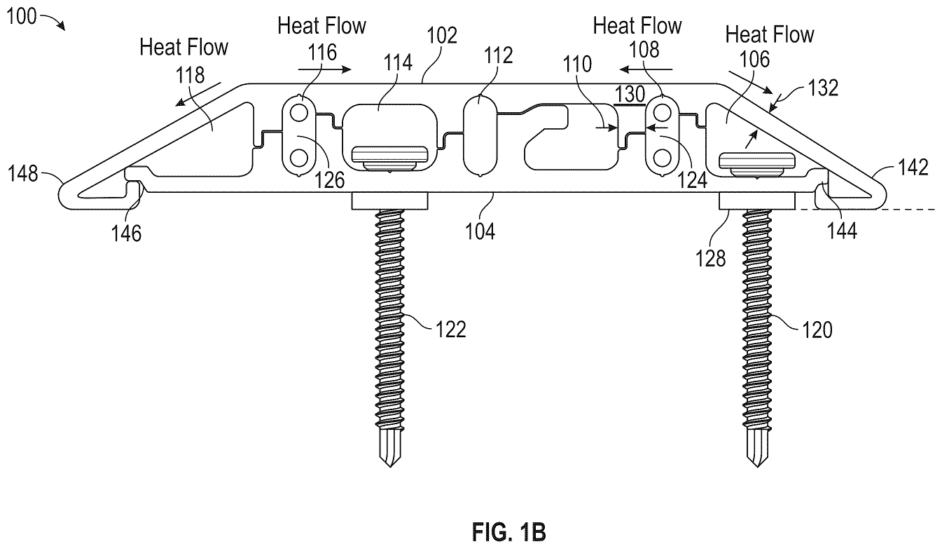

In various embodiments and with reference to FIGS. 1A-1B, a heat cable system 100 may comprise a housing 101 that is an assembly. The housing 101 may have a first or top portion 102 and a second or bottom portion 104. Heat cable system 100 may be secured or attached to building facades, building ledges, and/or building gutters with one or more fasteners, such as, for example, fastener 120 and fastener 122. Heat cable system 100 may also be adhered to building facades with any suitable mechanical or chemical fastener (e.g., staples, glue, butyl tape, and/or the like). Heat cable system 100 may also be placed in a gutter system and may be retained by its own weight and the structures of the gutter system.

In various embodiments, heat cable system 100 may be a clamshell assembly, where first portion 102 is removably coupled to second portion 104. While shown in a top and bottom configuration, heat cable system 100 may also employ detachable side structure or any other suitable structure configured to allow the user access to the one or more hollows or channel defined through heat cable system 100.

Heat cable system 100 may define one or more hollows or channels along the longitudinal length of the housing 101. For example, first portion 102 and second portion 104 may define a plurality channels or hollow passages. The channels may be configured as insulating channels that include void for air to facilitate heat transfer through the housing. For example, channel 110, channel 118 and/or the like may be insulating channels. The channels may also be configured to receive one or more heat cables. For example, channel 108, channel 112, channel 116, and/or the like may be sized to receive one or more heat cables, including, for example, heat cable 124, heat cable 126 and/or the like. Heat cable system 100 may include 1, 2, 3, and/or n number of heat cables depending on the environment and the application requirements. One or ordinary skill in the art, after reading the present disclosure, will appreciate that the size heat cable system and number of heat cable may be modified to meet the needs of any particular application and environment.

In various embodiments, a wall thickness 130 adjacent heat cable 124 may be thicker than other portions of the housing 101 to facilitate heat transfer. In this regard, heat may be drawn from heat cable 124 into the housing 101. The heat may flow from the center portions of the housing 101 to the outer surface to facilitate heat transfer to the environment, to melt ice. The outer portions of the of the housing 101 may have a wall thickness 132 that is thinner to facilitate heat transfer or flow into the environment.

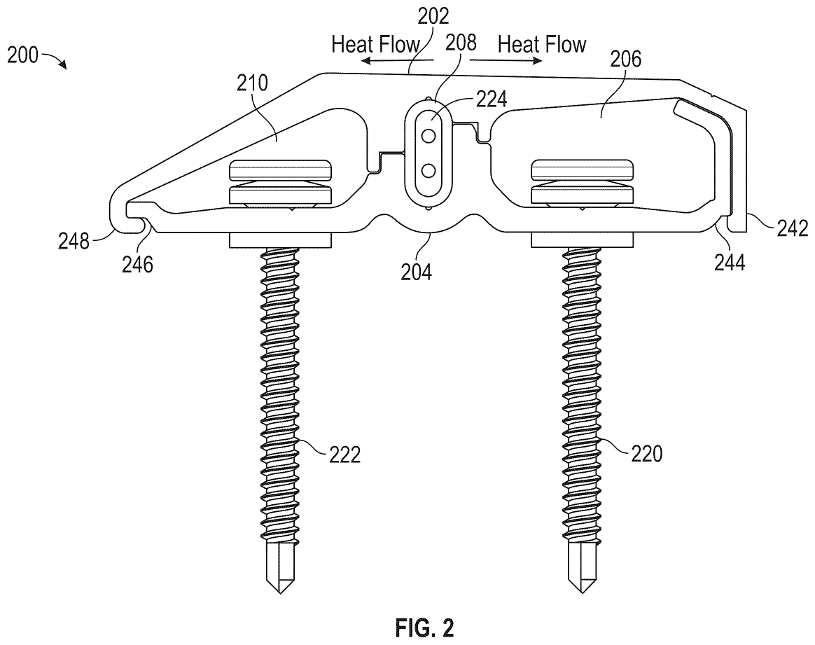

In various embodiments and with reference to FIG. 2, heat cable system 200 may define a central cavity 208. This cavity may be sized to receive heat cable 224. The central cavity 208 may be disposed between two insulating cavities 206 and 210. These insulating cavities may also be configured with attachment points or through holes that allow for fasteners 220 and 222 to secure the housing 201 to a building surface or gutter. Heat cable system 200 may also comprise a top portion 202 and a bottom portion 204 that are removably from one another. Top portion 202 and bottom portion 204 may be clip together or have an overlapping interference. In this regard, hook 248 of top portion 202 may be installed on tang or protrusion 246. Top portion 202 may be rotated onto bottom portion 204 such that clip 242 engages shelf 244 of bottom portion 204. In this regard, top portion 202 may snap on or be locked on to bottom portion 204.

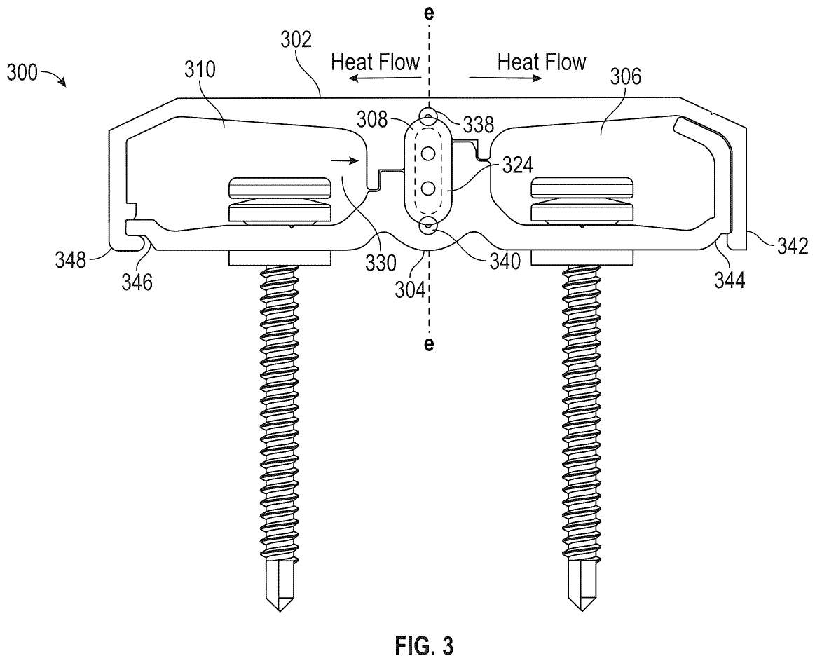

In various embodiments and with Reference to FIG. 3, heat cable system 300 may define a central cavity 308 along axis C. This cavity may be sized to receive heat cable 324. The central cavity 308 may be disposed between two insulating cavities 306 and 310. Central cavity 308 may include one or more insulting channel or air passages, such as, for example, channel 338, channel 340, and/or the like. Channel 338 and channel 340 may be disposed at any suitable position in cavity 308. Moreover, channel 338 and channel 340 may act as insulators for heat cable 324 and cause heat to transfer into the thicker wall portions of the housing 301. Heat cable system 300 may also comprise a top portion 302 and a bottom portion 304 that are removably from one another. Top portion 302 and bottom portion 304 may be clip together or have an overlapping interference. In this regard, hook 348 of top portion 302 may be installed on tang or protrusion 346. Top portion 302 may be rotated onto bottom portion 304 such that clip 342 engages shelf 344 of bottom portion 304. In this regard, top portion 302 may snap on or be locked on to bottom portion 304.

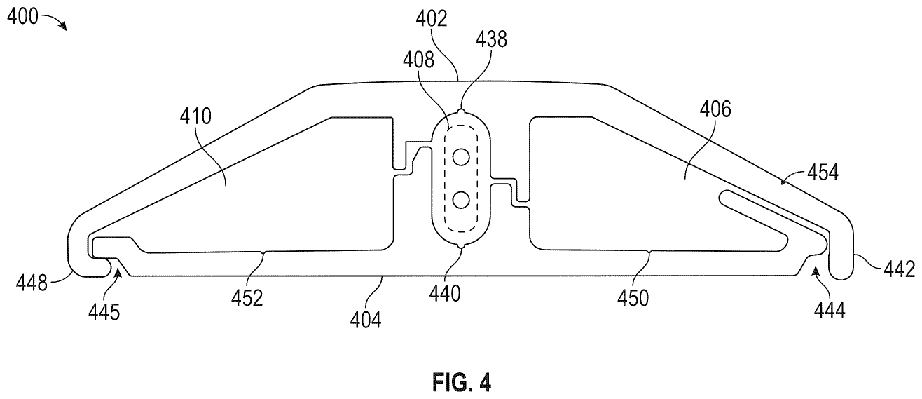

In various embodiments and with Reference to FIG. 4, heat cable system 400 may define a central cavity 408. This cavity may be sized to receive heat cable 424. The central cavity 408 may be disposed between two insulating cavities 406 and 410. Each of the insulting cavities may define a drill point 450 and a drill point 452. These indications show a user where a self-taping fastener to secure heat cable system 400 to a building structure or gutter. Central cavity 408 may include one or more insulting channel or air passages, such as, for example, channel 438, channel 440, and/or the like. Channel 438 and channel 440 may be disposed at any suitable position in cavity 408. Moreover, channel 438 and channel 440 may act as insulators for heat cable 424 and cause heat to transfer into the thicker wall portions of the housing 501. Heat cable system 400 may also comprise a top portion 402 and a bottom portion 404 that are removably from one another.

Top portion 402 and bottom portion 404 may be clipped together or have an overlapping interference. In this regard, hook 448 of top portion 402 may be installed on tang or protrusion 446. Top portion 402 may be rotated onto bottom portion 404 such that clip 442 engages shelf 444 of bottom portion 404. In this regard, top portion 402 may snap on or be locked on to bottom portion 404. Top portion 402 may include a fastener drill point 454. Drill point 454 can be a location to insert a fastener to attach or secure top portion 402 and bottom portion 404 together.

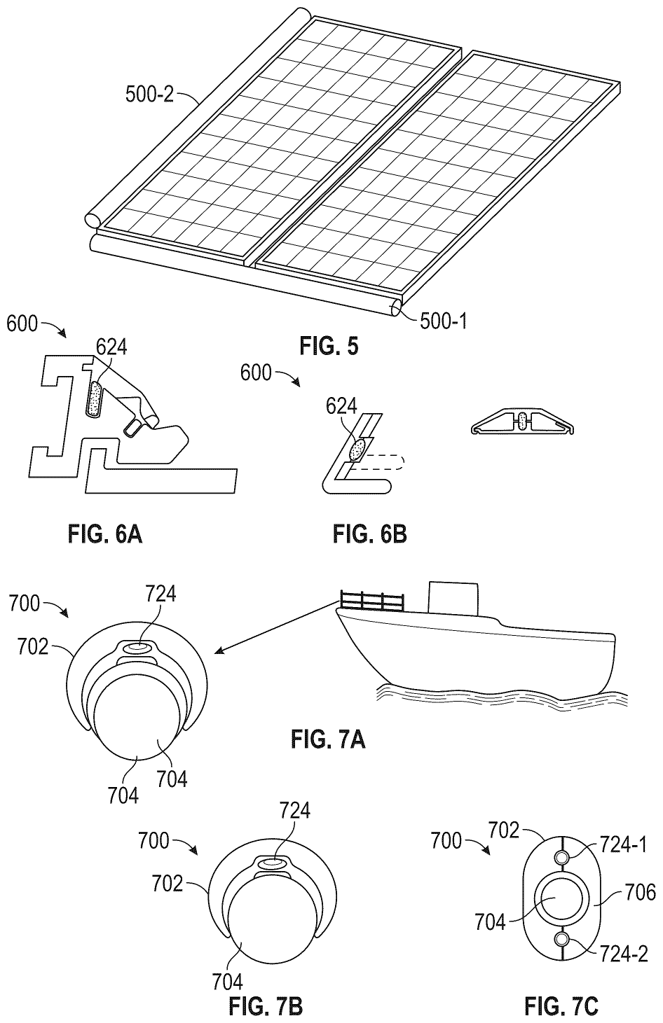

In various embodiments and with Reference to FIG. 5, heat cable system 500 may be deployed as part of a solar panel array or other roof mounted structure. For example, heat cable system 500-1 may be installed on a down slope edge of one or more solar panels in portrait orientation. In another example, heat cable system 500-2 may be installed on a down slope edge of one or more solar panels in landscape orientation.

In various embodiments and with reference to FIGS. 6A-6B, heat cable system 600 may be deployed as part of a snow management or snow retention system. Heat cable 624 may be installed in a cavity or channel of a snow management or snow retention system. In this regard, heat system 600 may also be a snow management or snow retention system.

In various embodiments and with reference to FIGS. 7A-7C, heat cable system 700 may be deployed as part of a railing system for stairs, on a ship, or as part of any other sailing system. Heat cable 724 may be installed between a cover 702 and a railing 704. Heat cable 724-1 and heat cable 724-2 may be installed in a clamp over assembly. In this regard, rail 704 may be disposed within a heat cable system 700 having a first side 702 and a second side 706.

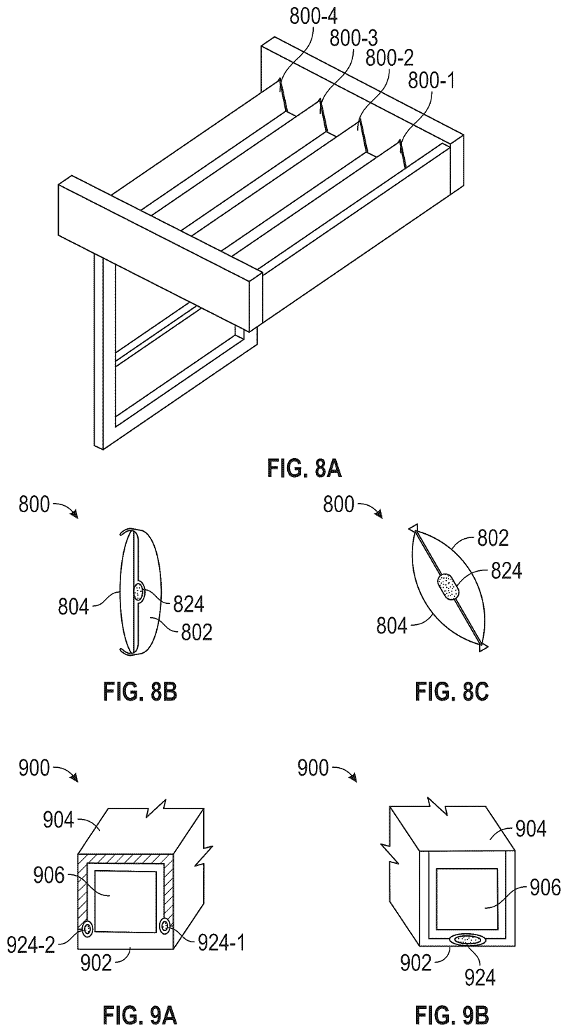

In various embodiments and with reference to FIGS. 8A-8C, heat cable system 800 may be deployed as part of a window louver system. Heat cable 824 may be installed between a first portion 802 and a second portion 804. The system may include a plurality of heat cable systems, such as, for example, heat cable system 800-1, heat cable system 800-2, heat cable system 800-3, heat cable system 800-4, and/or the like.

In various embodiments and with reference to FIGS. 9A-9B, heat cable system 900 may be deployed as part of a snow guard or architectural tubing system. Heat cable 924 may be installed between a first portion 902 and a second portion 904. The system may include a one or more heat cables, such as, for example, heat cable 924-1, heat cable system 924-2, and/or the like.

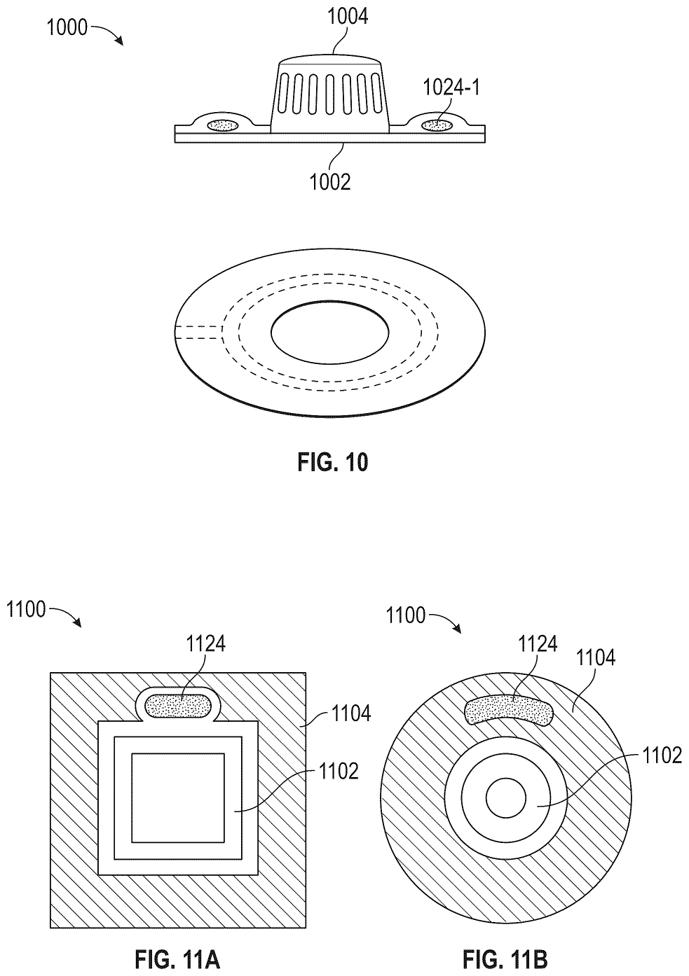

In various embodiments and with reference to FIG. 10, heat cable system 1000 may be deployed as part of a roof drain system. Heat cable 1024 may be installed between a first portion 1002 and a second portion 1004.

In various embodiments and with reference to FIGS. 11A-11B, heat cable system 1100 may be deployed as part of a rod or pipe cover system. Heat cable 1124 may be installed between a first portion 1102 and a second portion 1104.

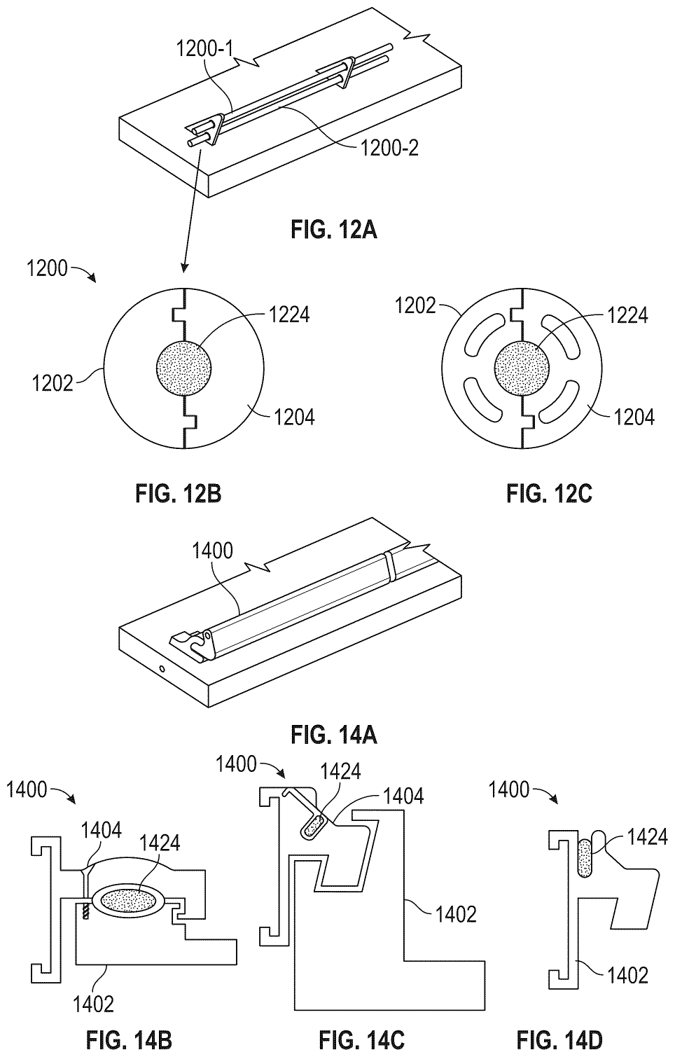

In various embodiments and with reference to FIGS. 12A-12C, heat cable system 1200 may be deployed as part of a pipe style snowguard system. Heat cable 1224 may be installed between a first portion 1202 and a second portion 1204. The system may include a plurality of heat cable systems, including, for example, heat cable system 1200-1, heat cable system 1200-2, and/or the like.

In various embodiments and with reference to FIGS. 14A-14D, heat cable system 1400 may be deployed as part of a ledge style snowguard system. Heat cable 1424 may be installed between a first portion 1402 and a second portion 1404. Heat cable system 1400 may also be installed in the body of first portion 1402 and/or second portion 1404.

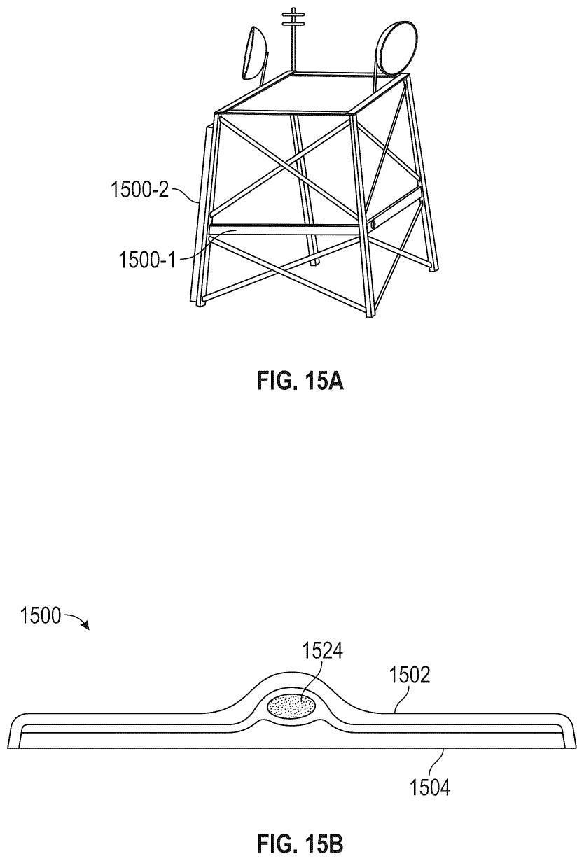

In various embodiments and with reference to FIGS. 15A-15B, heat cable system 1500 may be deployed as part of a radio tower or antenna system. Heat cable 1524 may be installed between a first portion 1502 and a second portion 1504. The system may include a plurality of heat cable systems, including, for example, heat cable system 1500-1, heat cable system 1500-2, and/or the like.

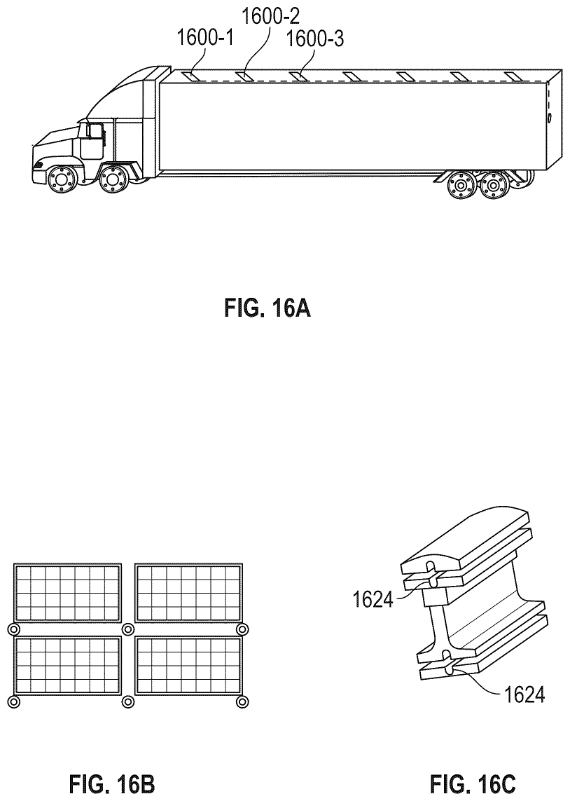

In various embodiments and with reference to FIGS. 16A-16B, heat cable system 1600 may be deployed on a tractor trailer. Heat cable system 1600 may be installed on the top exterior trailer surface. While the trailer is stopped for loading and unloading, heat cable system 1600 may be powered to melt and snow or ice that is accumulated on the top exterior surface of the trailer. Removing the snow and ice reduces the risk to other drivers when the trailer is in transport. The system may include a plurality of heat cable systems, including, for example, heat cable system 1600-1, heat cable system 1600-2, heat cable system 1600-3, and/or the like. Moreover, this plurality of heat cable systems 1600 may be set in series along an angle to divert any remaining snow and ice off of the trailer at an angle.

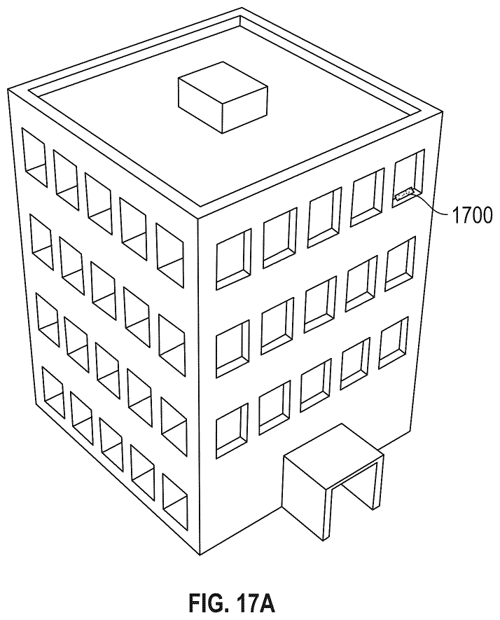

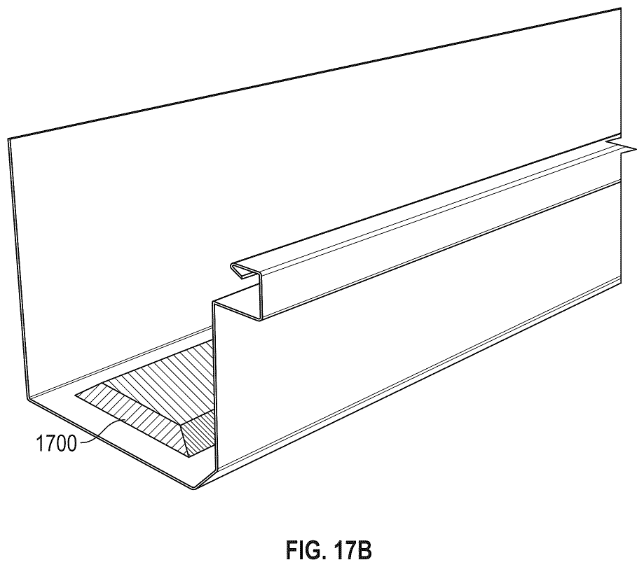

In various embodiments and with reference to FIGS. 17A-17B, heat cable system 1700 may be deployed on a building ledge. In this regard, heat cable system 1700 may be configured to melt ice and snow that accumulate on a building ledge.

Similarly, heat cable system 1700 may deployed in or as part of a building gutter system. In this regard, heat cable system 1700 may be configured to melt snow and ice accumulated in a building gutter system.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A heat cable system, comprising:
a housing comprising a first portion and a second portion, the first portion removably coupled to the second portion,
the hosing defining a first channel and a second channel,
the housing defining a first insulating cavity, a second insulating cavity, a third insulating cavity and a fourth insulating cavity,
the first channel being disposed between the first insulating cavity and the second insulating cavity,
the second channel being disposed between the third insulating cavity and the fourth insulating cavity;
a fastener installable through the housing to secure the housing to a structure;
a heat cable disposed in the first channel and the second channel, the heat cable in contact with a portion of the housing defining the first channel.

2. The heat cable system of claim 1, wherein the portion of the housing is thicker than an outer portion of the housing.

3. The heat cable system of claim 1, wherein the fastener is installable through the second portion in at least one of the first insulating cavity, the second insulating cavity, the third insulating cavity and the fourth insulating cavity.

4. The heat cable system of claim 1, wherein the first portion and the second portion are a clam shell assembly.

5. The heat cable system of claim 1, further comprising a central channel disposed between the second insulating channel and the third insulating channel.

6. The heat cable system of claim 5, wherein the central channel extends along an entire length of the housing.

7. The heat cable system of claim 1, wherein the portion of the housing is configured to facilitate heat transfer through the housing.

8. The heat cable system of claim 1, wherein the first portion and the second portion define portion of the housing that has a first wall thickness.

9. The heat cable system of claim 8, wherein an outer portion of the first portion is exposed to the environment.

10. The heat cable system of claim 9, wherein the outer portion has a second wall thickness.

11. The heat cable system of claim 10, wherein the first wall thickness is greater than the second wall thickness.

12. A heat cable housing, comprising:
a first portion and a second portion, the first portion removably coupled to the second portion,
the hosing defining a first channel and a second channel disposed between the first portion and the second portion,
the housing defining a first insulating cavity, a second insulating cavity, a third insulating cavity and a fourth insulating cavity,
the first channel being disposed between the first insulating cavity and the second insulating cavity, and
the second channel being disposed between the third insulating cavity and the fourth insulating cavity.

13. The heat cable housing of claim 12, wherein the first channel and the second channel are sized to receive a heat cable.

14. The heat cable housing of claim 12, wherein a portion of the housing defining the first channel has first wall thickness.

15. The heat cable housing of claim 14, wherein an outer portion of the first portion has a second wall thickness.

16. The heat cable housing of claim 15, wherein the first wall thickness is greater than the second wall thickness.

17. The heat cable housing of claim 12, wherein the first portion and the second portion are a clam shell assembly.

18. The heat cable housing of claim 12, further comprising a central channel disposed between the second insulating channel and the third insulating channel.

19. The heat cable housing of claim 18, wherein the central channel extends along an entire length of the housing.
